(19) United States
(12) Patent Application Publication
(10) Pub. No.: US 2016/0257878 A1
(43) Pub. Date: Sep. 8, 2016

(54) Systems and Methods for Reducing Treating Pressure of Crosslinked Carboxymethyl Cellulose-Based Fracturing Fluids

(71) Applicant: HALLIBURTON ENERGY SERVICES, INC., Houston, TX (US)

(72) Inventors: Yuntao Thomas Hu, The Woodlands, TX (US); Aaron Gene Russell, Humble, TX (US); Jeremy Holtsclaw, Kingwood, TX (US); Dipti Singh, Kingwood, TX (US); Eli Allen Schnoor, Kingwood, TX (US); Donald V. Durbin, Alvin, TX (US)

(73) Assignee: HALLIBURTON ENERGY SERVICES, INC., Houston, TX (US)

(21) Appl. No.: 15/028,170

(22) PCT Filed: Nov. 11, 2013
(86) PCT No.: PCT/US2013/069482

§ 371 Date: Apr. 8, 2016

(51) Int. Cl. C09K 8/90; C09K 8/88; E21B 43/26; C09K 8/68

(52) U.S. Cl. CPC C09K 8/90; C09K 8/685; C09K 8/887; E21B 43/26

(57) ABSTRACT

Systems and methods for reducing treating pressure of a fracturing fluid. The systems and methods may include a liquid; one or more low molecular weight carboxymethyl celluloses; one or more high molecular weight carboxymethyl celluloses; and a transition metal crosslinking agent. The average molecular weight of the one or more high molecular weight carboxymethyl celluloses may be at least 1.5 times greater than the average molecular weight of the one or more low molecular weight carboxymethyl celluloses. The one or more low molecular weight carboxymethyl celluloses may have a molecular weight up to approximately 500,000 and the one or more high molecular weight carboxymethyl celluloses may have a molecular weight greater than approximately 750,000.

### FIELD

The present disclosure relates to systems and methods for reducing treating pressure of fracturing fluids, and, more specifically, to systems and methods for crosslinked carboxymethyl cellulose-based fracturing fluids.

### BACKGROUND

Fracturing fluids may include various components to assist in the fracturing process, such as crosslinkable, hydrophilic polymers. For many applications, guar-based systems are used within subterranean formations in oil and gas wells to reduce treating pressures. These polymers are usually mixed with water at the surface to produce an aqueous solution that is pumped into the formation. A crosslinking agent is typically added to the solution at the surface, along with any other components of a fracturing fluid before being pumped into a wellbore for fracturing applications. Guar-based systems are often used as fracturing fluids due to their low cost as well as their being a crosslinkable, high molecular weight natural polymer. Guar-based systems, however, often leave unacceptably high levels of residue behind after treatment, hindering treatment and production.

Low molecular weight (LMW) crosslinked carboxymethyl cellulose (CMC) based fracturing fluids leave virtually no residue, resulting in better cleanup and improved production compared to traditional guar-based fluid systems. Low molecular weight crosslinked carboxymethyl cellulose based metal crosslinked fluid, however, can exhibit treating pressures higher than comparable guar-based fracturing fluids.

### BRIEF DESCRIPTION OF THE DRAWINGS

The accompanying drawings, which are included to provide a further understanding of the disclosure and are incorporated in and constitute a part of this specification, illustrate preferred embodiments of the disclosure and together with the detailed description serve to explain the principles of the disclosure. In the drawings:

FIG. 1 is a graph showing friction reduction of (1) 45 lbs./1000 gal. (0.54%) of CMC with MW of 410K gram/mole, and (2) a mixture of 25 lbs./1000 gal. (0.3%) of CMC with MW=410K and 5 lbs./1000 gal. (0.06%) of CMC with MW=840K measured at various flow rates in a 0.5″ diameter pipe.

FIG. 2 is a graph showing friction reduction of (1) 40 lbs. /1000 gal. (0.48%) of CMC with MW of 410K gram/mole, and (2) a mixture of CMC with MW=410K and CMCs with MW=740K measured at various flow rates in a 0.5″ diameter pipe.

FIG. 3 is a graph showing viscosity profiles of (1) 40 lbs. /1000 gal. (0.48%) of CMC with MW of 410K gram/mole, and (2) a mixture of 20 lbs. /1000 gal. (0.24%) of CMC with MW=410K and 10 lbs. /1000 gal. (0.12%) of CMC with MW=740K measured at various flow rates in a 0.5″ diameter pipe.

### DETAILED DESCRIPTION OF THE PREFERRED EMBODIMENTS

Systems and methods are described for reducing treating pressure in low molecular weight (LMW) metal crosslinked carboxymethyl cellulose (CMC) based fracturing fluids by partial substitution of one or more low molecular weight CMCs with one or more high molecular weight CMCs. The one or more low molecular weight CMCs and the one or more high molecular weight CMCs may operate synergistically to improve treating pressure characteristics of the fracturing fluid. The examples described herein relate to CMC-based fracturing fluids for illustrative purposes only. It is understood that the description herein can refer to any suitable polymers for fracturing fluids, including guar-based systems. In particular, the systems and methods may be used wherever reduction of treating pressure is desirable. Embodiments may be utilized to provide optimal treating pressure for any fluid used in oil well operations, e.g., fracturing fluids, drilling fluid, spacer fluid/flush, treatment fluids, settable fluids, production fluids, etc. However, embodiments described herein are particularly useful in the context of being used with CMC-based fracturing fluids because of the ability to reduce treating pressure.

Low molecular weight metal crosslinked carboxymethyl cellulose based fracturing fluids have desirable properties because, among other attributes, they leave virtually no residue, resulting in improved cleanup and increased production compared to traditional guar-based fluid systems. High-molecular-weight ionic polymers are usually less desirable for use in treating formations.

Surprisingly, adding a relatively small amount of carboxymethyl cellulose that has a molecular weight significantly higher than the base carboxymethyl cellulose may result in substantial reduction of treating pressure and overall polymer load while retaining rheological performance of the crosslinked fluid. By combining targeted amounts of both low- and high-molecular-weight CMCs in a fracturing fluid, the amount of low-molecular-weight polymer needed to achieve the desired polymer solution viscosity can be greatly reduced. In certain embodiments, other additives known to one of skill may be added to the fracturing fluid. In alternative embodiments, the polymer solution may only include active ingredients including the low molecular weight polymer and the high molecular weight polymer. Any other additives may not substantially affect the properties of the aqueous solution.

As referred to herein, low-molecular weight polymers are those polymers having an average molecular weight of up to approximately 600,000. Preferred low-molecular-weight polymers have an average molecular weight from about 300,000 to about 600,000, more preferably from about 400,000 to about 550,000, and still more preferably about 400,000 to about 500,000. In certain embodiments, low-molecular weight polymers are those polymers having an average molecular weight of approximately 450,000. In certain embodiments, values may vary by plus or minus about 20% or about 50,000. Molecular weight determinations may be made by any method, but preferably may be determined by multi-angle laser light scattering (MALLS).

As referred to herein, high-molecular-weight polymers are those polymers having an average molecular weight greater than about 500,000, more preferably greater than about 600,000. The high-molecular-weight polymers preferably have an average molecular weight from about 500,000 to about 2,000,000, more preferably from about 600,000 to about 1,500,000, more preferably about 700,000 to about 1,000,000, and still more preferably about 750,000. In certain embodiments, the high-molecular-weight polymers preferably have an average molecular weight of less than about 1,000,000, more preferably less than about 950,000. In certain embodiments, the high-molecular-weight polymers preferably have an average molecular weight of about 1,200,000. In certain embodiments, values may vary by plus or minus about 20% or about 50,000.

In certain embodiments, the average molecular weight of the high molecular weight polymers is at least 1.5 times greater than the average molecular weight of the low-molecular-weight polymers. In certain embodiments, the average molecular weight of the one or more high molecular weight polymers is less than 2.0 greater than the average molecular weight of the one or more low molecular weight polymers, and may be between approximately 1.1 and approximately 1.9 times greater than the average molecular weight of the one or more low molecular weight polymers. In certain embodiments, the high-molecular-weight polymer to low-molecular-weight polymer ratio is between approximately 5:1 to approximately 1:1.1, more preferably between approximately 4:1 to approximately 1.2:1, and still more preferably between approximately 3:1 to approximately 1.4:1. In other embodiments, the average molecular weight of the high molecular weight polymers is at least 3.0 times greater than the average molecular weight of the low-molecular-weight polymers. In alternative embodiments, the average molecular weight of the high molecular weight polymers is at least 4.0 times greater than the average molecular weight of the low-molecular-weight polymers.

In certain embodiments, the ratio of weight of the low molecular weight polymer to the high molecular weight polymers may be approximately 1:1. In certain embodiments, the ratio of weight of the low molecular weight polymer to the high molecular weight polymers is between approximately 3:1 and approximately 1:3, more preferably between approximately 2:1 and approximately 1:2, and most preferably between approximately 1.5:1 and approximately 1:1.

In certain embodiments, the resulting polymer mixture may have at least approximately 5% to approximately 15% increase in absolute friction reduction. This may represent an increase of up to 30% or greater in friction reduction relative to the low molecular weight polymer used alone without combination with a high molecular weight polymer.

The aqueous polymer mixture may be crosslinkable with transition metal ions to increase the overall viscosity of the system. Suitable transition metal ions may include, among others, Cr³⁺, Al³⁺, Ti⁴⁺, and Zr⁴⁺.

In general, the polymer concentration of the low molecular weight polymer and high molecular weight polymer mixture in a crosslinked system is less than the polymer concentration of a low molecular weight system for an approximately equivalent low shear viscosity both for a linear gel and crosslinked gel.

The mixture of low molecular weight polymer and high molecular weight polymer may have proppant transport capability equivalent to or better than the low molecular weight polymer at the same concentration that can be inferred from the higher low shear viscosity.

The polymers used herein are hydrophilic polymers that generally hydrate in water and are capable of being crosslinked in solution so that the polymers are interconnected with one another to form a gel. For convenience, mixtures of polymers and water are referred to herein as solutions. While certain embodiments have particular application to carboxymethyl cellulose, other polymers may be used as well and are well known to those skilled in the art. These include the polymers and copolymers of acrylic acid and acrylamide, polymethacrylamides and partially hydrolyzed polymethacrylamides, sulfonated acrylamide polymers, polyvinyl polymers, such as polyvinyl alcohol, polyvinyl acetate, and polyvinyl pyrrolidone, the polyalkylenoxides, and the ammonia salts and alkali metal salts thereof. Other suitable polymers are the polysaccharides, the cellulose ethers, such as ethyl cellulose and methyl cellulose, carboxyalkylcellulose, such as carboxyethyl-cellulose, and substituted and unsubstituted galactomannans, including guar gum.

The polymers are combined with a crosslinking agent to crosslink the polymers to form a crosslinked polymer gel. Various crosslinking systems can be employed and are well known to those skilled in the art. The crosslinking agents can be inorganic or organic. Examples of suitable inorganic crosslinking agents include the salts or complexes of the multi-valent metals such as chromium, zirconium, titanium and aluminum. Tri-valent metallic ions, such as chromium and aluminum, act as particularly good crosslinkers and are frequently added as chromium acetate, chromium citrate, chromium carboxylate, chromium chloride, and aluminum citrate. These metallic crosslinkers bond ionically with the polymers to form the crosslinked molecule. Organic crosslinking agents bond by covalent bonding and include phenols, aldehydes, including dialdehydes, and ethers. Examples of these organic compounds include phenol, resorcinol, formaldehyde and divinylether. Other suitable crosslinking agents used in forming the polymer gels, both inorganic and organic, are well known and will be readily apparent to those skilled in the art. The amount of crosslinker used will vary depending upon the type of polymer and crosslinking agent being used and the amount of crosslinking desired.

Because the crosslinking agent and polymers are usually mixed at the surface, it is usually necessary to control or slow the rate of crosslinking so that the polymers do not gel too quickly prior to being introduced into the formation being treated. Most organic crosslinking agents react at a comparatively slower rate such that the use of an additional delaying agent is usually unnecessary. The inorganic crosslinking agents, however, are often used with delaying agents to slow gelation rates and to allow sufficient time for the polymer solution to be placed within the formation prior to gelling. Suitable delaying agents for use with the inorganic crosslinking agents include the 1-to-4 carbon carboxylic acids, which include maleic acid, malonic acid, citric acid, acetic acid and their derivative salts. The carboxylic acid delaying agents form a carboxylate delay ligand with the cationic metal ions and slow the crosslinking reaction. Other delay agents may also be used and are well known to those skilled in the art.

When combining the low-molecular-weight and high-molecular-weight polymers in solution, a reduced amount of polymer may be used by comparison to conventional polymer gel solutions to obtain desired properties of the mixture. This is due to the effect created by the presence of the high-molecular-weight polymers, which cause an increase in the viscosity of the final gel. The selected concentration of high- and low-molecular-weight polymers may vary depending upon the characteristics of the formation being treated. A preferred concentration range for the low-molecular-weight polymers for most applications maybe from about 0.1 to about 3 weight percent of the polymer solution, with a more preferred concentration ranging from about 0.1 to about 2 weight percent of the polymer solution, and a still more preferred concentration ranging from about 0.15 to about 0.5 weight percent of the polymer solution. For the high-molecular-weight polymers, a preferred concentration range is from about 0.05 to about 2.0 weight percent of the polymer solution, with a more preferred concentration from about 0.1 to about 1.0 weight percent of the polymer solution, and with a still more preferred concentration from about 0.15 to about 0.5 weight percent of the polymer solution.

The embodiments described herein can be understood further with reference to the following examples.

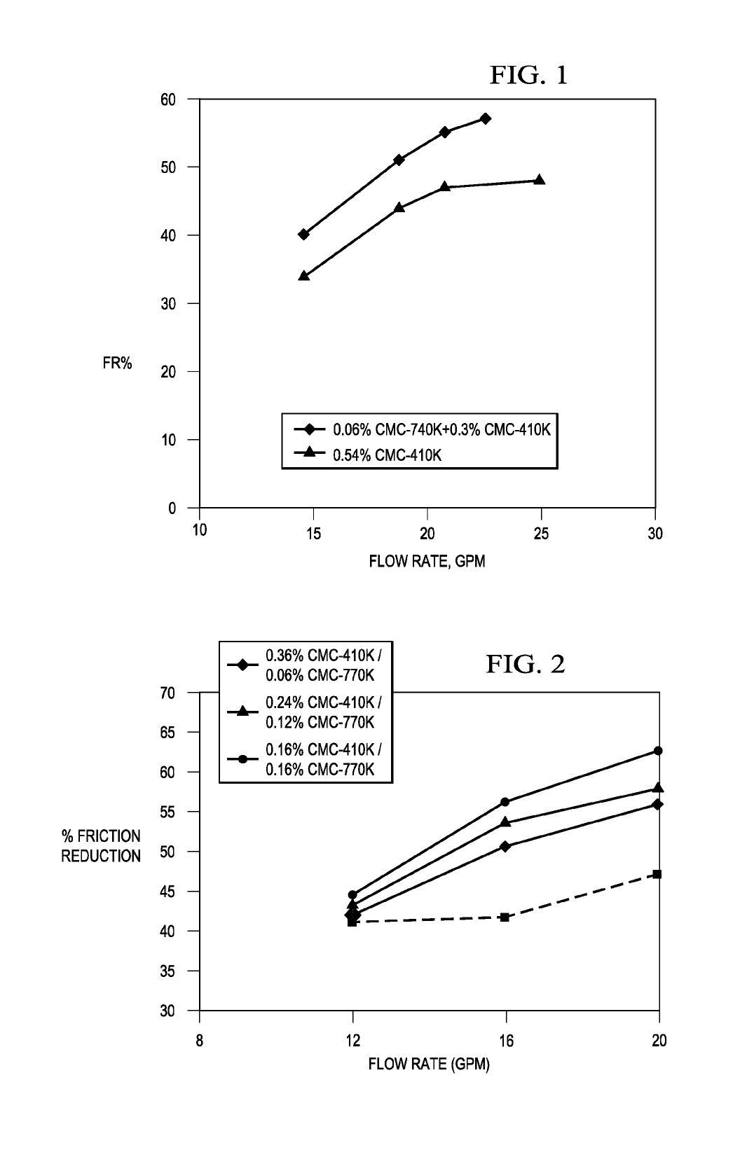

FIG. 1 is a graph showing friction reduction of (1) 45 lbs./1000 gal. (0.54%) of CMC with MW of 410K gram/mole, and (2) a mixture of 25 lbs./1000 gal. (0.3%) of CMC with MW=410K and 5 lbs./1000 gal. (0.06%) of CMC with MW=840K measured at various flow rates in a 0.5″ diameter pipe. For reference, 10 lbs.=0.12%, 20 lbs.=0.24%, 30 lbs.=0.36%, 40 lbs.=0.48%, 50 lbs.=0.60%, 60 lbs.=0.72%, 70 lbs.=0.84%, 80 lbs.=0.96%, and 83 lbs.=1%.

As shown in FIG. 1, the base polymer is a CMC with a molecular weight of about 410K gram/mole and the added polymer is a polyanionic cellulose with a molecular weight of 740K. FIG. 1 shows that the addition of only 5 lbs. of the high MW cellulose enhances the absolute friction reduction by approximately 7% to approximately 10% over the tested flow rate range. As shown, the relationship between performance and amount of high MW cellulose may not be linear.

FIG. 2 is a graph showing friction reduction of (1) 40 lbs. /1000 gal. (0.48%) of CMC with MW of 410K gram/mole, and (2) a mixture of CMC with MW=410K and CMCs with MW=740K measured at various flow rates in a 0.5″ diameter pipe.

As shown in FIG. 2, the added polymer has a MW of approximately 770K gram/mole. Again, the addition of the high MW polymer increases the friction reduction significantly.

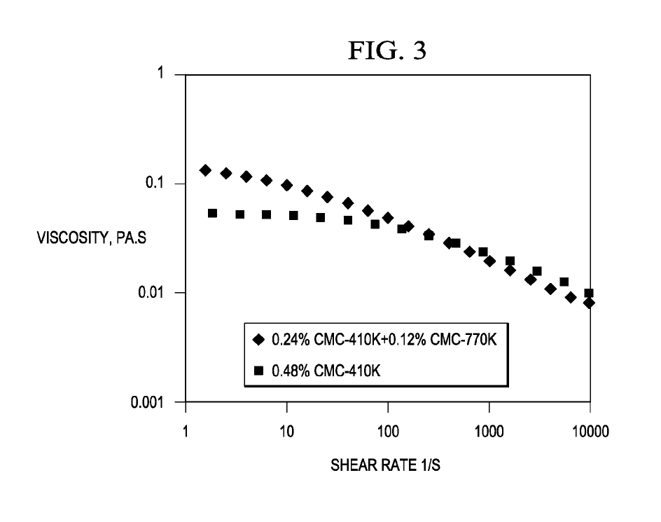

FIG. 3 is a graph showing viscosity profiles of (1) 40 lbs. /1000 gal. (0.48%) of CMC with MW of 410K gram/mole, and (2) a mixture of 20 lbs. /1000 gal. (0.24%) of CMC with MW=410K and 10 lbs. /1000 gal. (0.12%) of CMC with MW=740K measured at various flow rates in a 0.5″ diameter pipe. As shown in FIG. 3, the low shear viscosity of the mixture at approximately 0.36% total polymer loading is also significantly larger than that of the single component polymer at approximately 0.48% polymer loading. The larger viscosity at the low shear rates indicates better proppant transport capability.

Previously, attempts had been made to reduce the treating pressure of CMC-metal crosslinked systems by adding a small amount of friction reducers, such as FR-66 sold by HALLIBURTON, or other polymers that are known to be good friction reducers, such as guar, derivatized guar, xanthan, etc. Some of these approaches can indeed reduce the treating pressure to a certain extent. These polymer, however, are chemically different than CMCs and may leave residues upon breaking, which weakens the advantage of CMC-metal crosslinked systems, which are substantially “residue free”. Addition of high molecular weight CMC can assist in achieving desired treating pressure without introducing complicated and potentially destructive chemistry to the fluid system. In certain embodiments, the system may be substantially “residue free” as the added polymers are chemically similar to the base polymer with the main difference being the molecular weight.

Additionally, the added high molecular weight CMC may participate fully in the delayed crosslinking process and enhance the viscosity of the crosslinked gel. Therefore, the base polymer loading can be reduced. Depending on the price ratio between the high molecular weight polymer and the low molecular weight polymer, the additional additive may render no add-on cost or even reduce the cost as compared to previous approaches.

The exemplary fracturing fluids disclosed herein may directly or indirectly affect one or more components or pieces of equipment associated with the preparation, delivery, recapture, recycling, reuse, and/or disposal of the disclosed fracturing fluids. For example, the disclosed fracturing fluids may directly or indirectly affect one or more mixers, related mixing equipment, mud pits, storage facilities or units, composition separators, heat exchangers, sensors, gauges, pumps, compressors, and the like used generate, store, monitor, regulate, and/or recondition the exemplary fracturing fluids. The disclosed fracturing fluids may also directly or indirectly affect any transport or delivery equipment used to convey the fracturing fluids to a well site or downhole such as, for example, any transport vessels, conduits, pipelines, trucks, tubulars, and/or pipes used to compositionically move the fracturing fluids from one location to another, any pumps, compressors, or motors (e.g., topside or downhole) used to drive the fracturing fluids into motion, any valves or related joints used to regulate the pressure or flow rate of the fracturing fluids, and any sensors (i.e., pressure and temperature), gauges, and/or combinations thereof, and the like. The disclosed fracturing fluids may also directly or indirectly affect the various downhole equipment and tools that may come into contact with the cement compositions/additives such as, but not limited to, wellbore casing, wellbore liner, completion string, insert strings, drill string, coiled tubing, slickline, wireline, drill pipe, drill collars, mud motors, downhole motors and/or pumps, cement pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like.

All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values.

Although the foregoing description is directed to the preferred embodiments of the disclosure, it is noted that other variations and modifications will be apparent to those skilled in the art, and may be made without departing from the spirit or scope of the disclosure. Moreover, features described in connection with one embodiment of the disclosure may be used in conjunction with other embodiments, even if not explicitly stated above.

What is claimed is:

1. A method of treating a subterranean formation, the method comprising:
preparing an aqueous solution of polymers comprising one or more low molecular weight polymers and one or more high molecular weight polymers, wherein the average molecular weight of the one or more high molecular weight polymers is at least 1.1 times greater than the average molecular weight of the one or more low molecular weight polymers, and wherein the one or more low molecular weight polymers have a molecular weight up to approximately 600,000 and the one or more high molecular weight polymers have a molecular weight greater than approximately 500,000; and
injecting the aqueous solution with a crosslinking agent into a subterranean formation via a wellbore.

2. The method of claim 1, wherein the one or more low molecular weight polymers are low molecular weight carboxymethyl celluloses.

3. The method of claim 1, wherein the one or more high molecular weight polymers are high molecular weight carboxymethyl celluloses.

4. The method of claim 1, wherein the one or more low molecular weight polymers are low molecular weight carboxymethyl celluloses, and wherein the one or more high molecular weight polymers are high molecular weight carboxymethyl celluloses.

5. The method of claim 1, wherein the average molecular weight of the one or more high molecular weight polymers is at least 1.5 times greater than the average molecular weight of the one or more low molecular weight polymers.

6. The method of claim 1, wherein the one or more low molecular weight polymers have a molecular weight up to approximately 500,000.

7. The method of claim 1, wherein the one or more high molecular weight polymers have a molecular weight greater than approximately 750,000.

8. The method of claim 1, wherein the crosslinking agent is a transition metal.

9. The method of claim 8, wherein the transition metal is selected from the group consisting of Cr³⁺, Al³⁺, Ti⁴⁺, and Zr⁴⁺, and combinations thereof.

10. An aqueous polymer composition comprising:
water;
one or more low molecular weight polymers;
one or more high molecular weight polymers, wherein the average molecular weight of the one or more high molecular weight polymers is at least 1.1 times greater than the average molecular weight of the one or more low molecular weight polymers, and wherein the one or more low molecular weight polymers have a molecular weight up to approximately 600,000 and the one or more high molecular weight polymers have a molecular weight greater than approximately 750,000; and
a crosslinking agent for crosslinking the hydrophilic polymers to form a gel.

11. The composition of claim 10, wherein the one or more low molecular weight polymers are low molecular weight carboxymethyl celluloses.

12. The composition of claim 10, wherein the one or more high molecular weight polymers are high molecular weight carboxymethyl celluloses.

13. The composition of claim 10, wherein the one or more low molecular weight polymers are low molecular weight carboxymethyl celluloses, and wherein the one or more high molecular weight polymers are high molecular weight carboxymethyl celluloses.

14. The composition of claim 10, wherein the average molecular weight of the one or more high molecular weight polymers is at least 1.5 times greater than the average molecular weight of the one or more low molecular weight polymers.

15. The composition of claim 10, wherein the one or more low molecular weight polymers have a molecular weight up to approximately 500,000.

16. The composition of claim 10, wherein the one or more high molecular weight polymers have a molecular weight up to approximately 950,000.

17. The composition of claim 10, wherein the crosslinking agent is a transition metal.

18. The composition of claim 10, wherein the transition metal is selected from the group consisting of Cr³⁺, Al³⁺, Ti⁴⁺, and Zr⁴⁺, and combinations thereof.

19. A fracturing fluid comprising:
a liquid;
one or more low molecular weight carboxymethyl celluloses;
one or more high molecular weight carboxymethyl celluloses, wherein the average molecular weight of the one or more high molecular weight carboxymethyl celluloses is at least 1.5 times greater than the average molecular weight of the one or more low molecular weight carboxymethyl celluloses, and wherein the one or more low molecular weight carboxymethyl celluloses have a molecular weight up to approximately 500,000 and the one or more high molecular weight carboxymethyl celluloses have a molecular weight greater than approximately 750,000; and
a transition metal crosslinking agent.

20. The composition of claim 19, wherein the transition metal is selected from the group consisting of Cr³⁺, Al³⁺, Ti⁴⁺, and Zr⁴⁺, and combinations thereof.
